(19) United States
(12) Patent Application Publication
(10) Pub. No.: US 2009/0260757 A1
(43) Pub. Date: Oct. 22, 2009

(54) ROLLFORMER FOR COMBINING AN ARCHITECTURAL SHEET WITH A SOLAR PANEL AND METHOD

(75) Inventors: Dale Kroskey, Fayetteville, GA (US); Matt Beers, Charlotte, NC (US); Geoffrey Louis Stone, Peachtree City, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: METALFORMING, INC, Peachtree City, GA (US)

(21) Appl. No.: 12/424,979

(22) Filed: Apr. 16, 2009

Related U.S. Application Data
(60) Provisional application No. 61/045,454, filed on Apr. 16, 2008.

(51) Int. Cl. B32B 38/18; B32B 37/10

(52) U.S. Cl. 156/249; 156/522

(57) ABSTRACT

A machine is provided for combining thin flexible solar film panels with a metal sheet to serve as a roof panel for a building. The machine has reels for holding rolls of metal and solar film. The solar film panel has an adhesive with a backing for protecting the adhesive. Means are provided for unrolling both the metal and solar film and for removing the backing from the solar film panel. A mechanical brake device is provided for parting the solar film panel from the adhesive film at the desired length which is sometimes shorter than the length of the metal sheets. A recoiler is provided for removing the backing from the solar film panel. Pressure rollers are provided for pressing the solar film panel to the metal so that the adhesive binds the film panels to the metal. The rollformer component cuts the metal into sheets and configures the metal into the desired structure for the roofing panel.

### CROSS-REFERENCE TO RELATED APPLICATION

This application claims priority to U.S. Provisional Application having Ser. No. 61/045,454 filed Apr. 16, 2008, which is entirely incorporated hereby by reference.

### FIELD OF THE INVENTION

This present invention discloses a machine and method for adhering flexible photovoltaic film panels onto metal supplied from a roll for forming a combination solar and roof panel. The photovoltaic film panels and the metal to which it is adhered are supplied on rolls which are fed from reels into a rollformer with a special attachment to produce the roofing panel with the photovoltaic film panels.

### BACKGROUND OF THE INVENTION

Photovoltaic devices provide reliable sources of electrical energy. Thin film photovoltaic devices are particularly advantageous since they are relatively low in cost, flexible, and capable of being manufactured in relatively large sizes by continuous deposition processes. Such thin film devices can be encapsulated in transparent, durable, flexible polymeric bodies, and are ideally suited for building mounted installations.

These thin photovoltaic film panels can be applied to roofs by adhering the film panels directly to the roof. An adhesive can be placed on the bottom of the film panel to which a backing material is attached. The backing material can be removed and the film panel placed on the roof so that the adhesive will adhere the film to the roof. This photovoltaic film panels can be applied to the roof in areas where the roof receives sufficient sunlight.

The electricity of the photovoltaic film panels is transmitted to contact terminals which typically extend from one end of the photovoltaic area of the panel, and may be connected to a junction box or other connector device for transmitting to supply power to the building or into the electricity grid that supplies a city or an area.

The thin photovoltaic film can be placed on a roll or reel and supplied to a roof by unrolling the film and removing the backing and pressing the adhering film to the roof. This manual process is a very labor intensive procedure and sometimes resulted in the photovoltaic film not being properly adhered to the roof. Roofs are subjected to high winds and other weather conditions that may damage or remove the photovoltaic material.

A machine and method are needed for applying the photovoltaic film panels to roofs to save labor costs and to improve reliability of the adhesion of the film panels to the roof.

### BRIEF DESCRIPTION OF THE DRAWINGS

FIG. 1 is a schematic drawing of a rollformer with decoiler for unwinding coils of metal and solar panels and laminating the metal and solar panels together and feeding into the rollformer for producing a structure of the desired configuration.

FIG. 2 is a schematic drawing of a notching device for punching holes in the metal coming off of the unwinding coil as shown in FIG. 1.

FIG. 3 is the cross-section of one type of metal roofing panel with a solar panel attached.

### DETAILED DESCRIPTION OF THE INVENTION

The present invention relates to a process by which a solar film panel with an adhesive on the bottom and a backing protecting the adhesive is combined with metal to produce a combination sheet of a solar panel and a metal roofing material. This combination solar film panel and metal can used for roof panels, wall panels and ground mount solar panels.

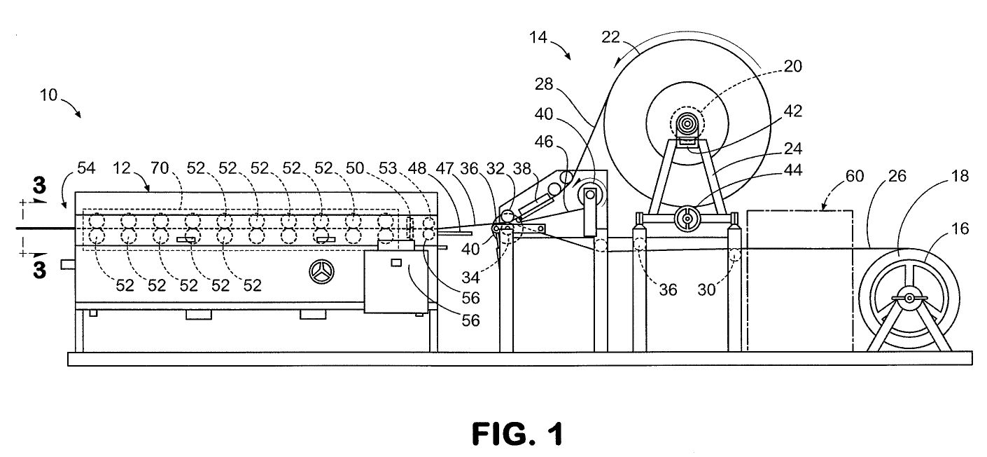

As shown in FIG. 1. a rollformer with decoiler and laminator 10 has a rollformer 12 section with a decoiler and laminator 14 section which has a decoiler 20 for the solar panels for holding a coil of solar panels 22. The decoiler and laminator 14 has frame 24, with a decoiler reel 16 for metal which holds a metal coil 18. The metal 26 is threaded past idler roller 36 and between a top pressure roller 32 and a bottom pressure roller 34. A spray system and wiper 30 may used to clean the metal 26 for processing.

A means is needed for removing the backing 46 from the solar panels. A recoiler with a motor 40 may be used to remove the backing 46 from the solar panels so that the adhesive can adhere the solar panel to the metal.

The solar panels with adhesive applied can be disconnected from the solar coil 22 by using a brake, such as a mechanical brake 42, attached to the solar decoiler 20 holding the solar coil 22. This brake 42 will apply tension at the proper time to allow the previously perforated adhesive backing 46 to part or break free from the adhesive. The length of the solar panel may be less than that of the metal sheet to which it is applied.

The metal and solar films are pressed together by pressure rolls 32, 34 so the adhesive binds them together. Then the metal and solar film are run through a rollformer 12 to form the edge profiles for the metal sheet 26 and any holes or other features that are needed. This rollformer is made by Schlebach-Maschinen GmbH, Friedewald, Germany. Other rollformers may be used. This type of machine is often taken to the customer's house or building and the coil of steel is then unrolled and cut and bent into architectural sheets of different lengths and configuration. The machine can also be used in a factory environment. The roof, soffit, nail strip and other configurations and metal can be formed by the machine shown in FIG. 1.

The following is a list of parts for the machine of this invention:

### Parts List

10. Rollformer with decoiler and laminator
12. Rollformer
14. Decoiler and laminator
16. Decoiler reel for metal
18. Metal coil
20. Decoiler for solar panels held together by a backing
22. Coil of solar panels
24. Frame for Decoiler and laminator
26. Metal
28. Solar panels with backing
30. Spray system and wiper
32. Top pressure roller
34. Bottom pressure roller
36. Idler rollers
38. Side guides for aligning solar panels
40. Recoiler with motor
42. Brake for holding solar coil stationary.
44. Cross Adjust Handwheel
46. Backing for solar panels
47. Laminated metal and solar panels
48. Rollformer side guides for aligning metal and solar panels
50. Metal cutter
52. Rolling dies
53. Drive rollers
54. Machine exit
56. Rollformer control
60. Notching device
62. Hydraulic cylinders
64. Metal punches
72. Forming rollers
80. Solar panel
82. Photovoltaic section of panel
84. Electrical contacts.
90. Cross section of panel
92. Solar panel
94. Metal panel
96. Female edge
98. Male edge

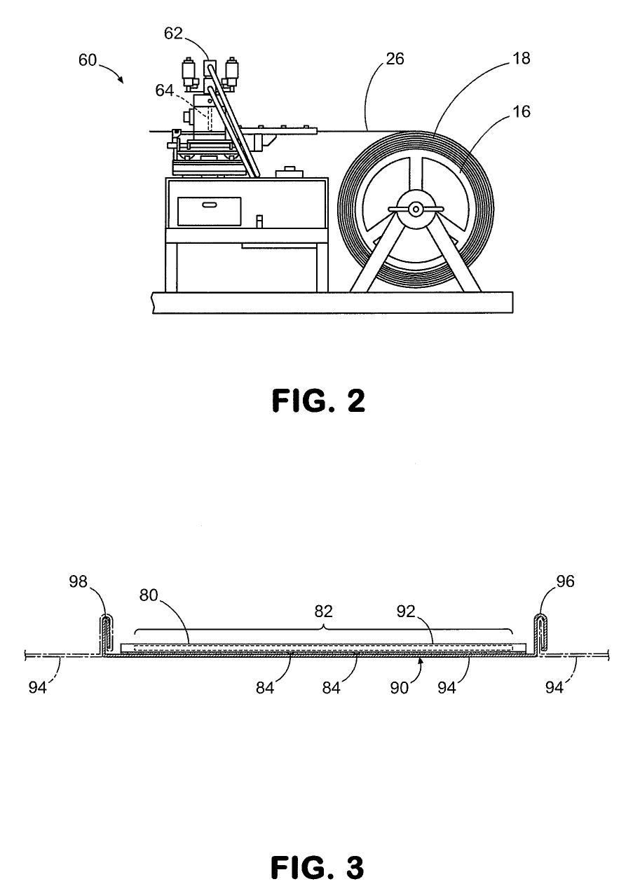

The rollformer 12 in FIG. 1 may have a notching device 60 as shown in more detail in FIG. 2 for making notches in the steel after it is rolled off of the metal decoiler reel 16. The rollformer 10 can be placed on a trailer for transporting to the installation site. After being notched the steel is transported into the rollformer 12 where it is configured and cut into sheets. This notching device 60 can be used to notch the steel that will become the rollformed flanges of the panels, or could also be used to notch an access hole in the panel to allow access to bottom mounted electrical contacts that could be used in some building applications.

Nearly any metal that has sufficient flexibility and thinness can be formed on the rollformer 10. Among these metals are copper, zinc, stainless steel, galvanized steel, pre-painted steel, gavalume, and aluminum. These metals are placed on the decoiler reel 16 so that they can be unrolled freely.

The solar panels in a coil 22 can be placed on a similar decoiler 20 which can be unrolled freely. Any type of photovoltaic film panels of sufficient flexibility can be used with this invention. This solar film panels 80 may have an adhesive on the bottom to which a backing 46 is applied. This backing 46 is removed from the solar film panels by recoiler with a motor 40. The solar coil 22 can be adjusted laterally or perpendicular to decoiling (processing) direction with the cross adjust hand-wheel 44 to provide accurate alignment of the solar panels 28 to the metal 26, and to accommodate the various panel widths and seam configurations.

One type of film that can be combined with metal on the rollformer 10 is a thin film that has an amorphous silicon solar cell design. The amorphous silicon is desirable because it can be made into a very thin material. Many other types of thin film can be utilized. Other technologies such as CIGS, CdTE or other aSi technologies could be used provided they are packaged in such a manner to perform in the roofing environment. An adhesive can be placed on the back of the panel with a backing 46. It can be adhered to metal with the same type of machine 10 described herein.

A specific thin photovoltaic film panel is solar laminate PVL-Series manufactured by Unisolar Ovinic LLC. Model PVL-136 has the amorphous silicon solar cells encased in a laminate of ethylene tetrafluoroethylene polymer (ETFE). An adhesive such as HelioBond PVA 600BT, which is a thermal butyl adhesive tape, can be used for adhering the photovoltaic film panels to a surface such as a roof. This photovoltaic film can be as thin as 4 mm. The solar panels as shown in FIG. 3 have photovoltaic section 82 and may have low profile electrical contacts soldered in place, or flat wires attached so as to not disturb the laminating process. Low profile electrical junction boxes may be attached to the solar panel prior to installation on the structure. These boxes may use flat wire to fold and crimp the connection, or be of a simple male/female spade connector with a potted protective cover.

Any type of photovoltaic film panel which can be rolled into a coil and can be used to form the combination of a photovoltaic film panel and a metal panel.

Prior to entering the rollformer 12, the metal 26 is pulled off of metal coil 18 and the solar film panels 27 are pulled off of solar film coil 22 by drive 53 rollers. The metal and the photovoltaic film panel travel from right to left as shown in FIG. 1. In this figure the solar film panels 28 are located above the metal 26, but it should be realized that the solar film panels 28 could be placed behind or in front of the metal coil 18 or any other convenient location.

In respect to FIG. 1, the operator loads a solar panel coil 22 and closes the hinges on the tension brake 42 and the bearing assemblies (not shown). The operator manually positions the solar panel 28 relative to the pressure rollers 32, 34 using the cross adjust handwheel 44. The operator also sets side guides 38 located just prior to the pressure rollers 32, 34.

The operator then loads an empty core onto the cantilevered release liner take-up shaft or recoiler with a motor 40 and attaches the leader film to the core of the recoiler. The operator then threads the solar panel through the machine, under the machine encoder (not shown), and winds the leader film up to position the edge of the solar panel at the peel plate adjacent pressure rollers.

The pressure rollers 32, 34 are in the open position. The metal is threaded through the rollers and into the rollformer 12. When a solar panel is needed, the operator activates the pressure rollers and a pre-set amount of solar panel indexes into rollers 32, 34. The bottom roller 34 then moves up, bringing the metal sheet 26 to the laminating position.

The drive rollers 53 of the rollformer 12 then pulls the metal and solar panel through the pressure rollers 32, 34 for the length of the solar panel, e.g. 18 feet. When the length of solar panel has been fully applied, the brake 42 on the decoiler 20 actuates stopping the coil 22 and allowing the solar panel 80 to separate from the coil 22 at the glue gap between solar panels 80. While the solar panel 80 is being applied, the recoiler 40 shaft is winding up the solar panel backing 46. For positioning a solar panel 80 on the leading edge of the metal, a motor (not shown) is mounted adjacent the pressure rollers 32, 34 to reverse the metal 26 from the rollformer 12 after it has been sheared.

The rollformer 12 has a pair of guides 48 to make sure that the laminated metal and solar panels 47 are properly aligned in entering into the rollformer 12.

The rollformer 12 has a metal cutter 50 to cut the metal prior to the lamination of the metal and the photovoltaic film panels being processed. This metal cutter 50 may be independent of cutting or separating the solar panel backing 46. It may be necessary to cut the backing for the solar panels 46 independently of the metal 26. The solar panels may be of a length shorter than the length of the metal. Having a perforated backing 46, and brake 42 on the solar coil decoiler 20 and a metal cutter 50 will allow the independent cutting of the two components. There typically would be a gap on the metal where there is no solar film panel so that the metal can be cut easily. It will be necessary for the metal cutter 50 to be programmed so that it does not cut the solar panel.

The metal cutter 50 can be a rotary shear which is two independent sets of rolling knives. It may have a lower wheel and an upper wheel that act as a pair of rotary scissors or rotary shears and cut the metal traversing from one side of the sheet to the other. The metal cutter 50 could also be a guillotine shear which would move straight down. The metal cutter could also be a flat bottom blade with just one wheel cutting across it. A pair of rotary wheels may be preferred.

The combination of the metal and the solar film panel enter the rollformer 12 which consists of a series of rolling dies 52 that will form the metal flanges into the various configurations; it could be a snap lock, mechanical lock, or nail strip panel of varying heights. There are multiple pairs of rolling dies 52 on each side of the rollformer 12 arranged in cassettes for rapid profile changeover. These cassettes mount on each side of the frame of the rollformer 12. These rollformer 10 have drive rollers 53 to help form the profile on each side of the sheet and to move the sheet through the rollformer 10. One of the cassettes forms a male side of the sheet with forming rollers 52 and the other forms the female side so the metal panels can be fitted together.

After rollforming the combination of the metal and the photovoltaic film panels, the combination will exit the rollformer 12 at exit 54. This will be a strip of metal with a solar panel firmly attached which can be used to form a roof for a building.

The rollformer with decoiler and laminator 10 preferably have a single control 56. controlling both operations.

FIG. 1 shows the photovoltaic film panels in a coil form. However, this film panel could be provided in sheet form using some type of stacking device so that sheets of photovoltaic film panels could be dropped on to the metal coming from a metal coil with any backing on the adhesive removed and then going through the pressure rolls 32, 34. Under these circumstances, it would not be necessary to cut the sheets of photovoltaic film.

FIG. 3 illustrates a cross section 90 of a photovoltaic film panel 92 on a metal panel 94. This panel has a female edge 96 and a male edge 98. This combination of photovoltaic film panel and metal panel has electrical contacts 84 to distribute the electricity generated by the solar cells.

It is possible to use the process and machine of this invention with in-plant rollformers as it is preferred to use on-site rollformers.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

1. A machine for combining a thin flexible solar film panel with a metal sheet comprising:
a reel for holding a coil of metal,
a reel for holding a coil of a plurality of solar film panels, each of which has a top for exposure to the sun and a bottom, with the bottoms of each panel having an adhesive with a backing extending over the bottoms of the panels for protecting the adhesive,
means for unrolling the metal and solar film panels from their respective coils,
means for removing the backing from the solar film panels,
means for pressing the solar film panels to the metal so that the adhesive on the bottom of the solar film panel adheres to the metal,
a rollformer for cutting the metal of the combined metal and solar film panels into sheets and configuring the metal into the desired structure.

2. The machine of claim 1 in which the means for pressing the solar film panels to the metal is at least one pressure roller which exerts pressure on the solar film panels and the metal pressing the metal and solar film panels together.

3. The machine of claim 2 in which the means for pressing the solar film panels to the metal is a least one pair of pressure rollers between which the solar film panels and metal is run.

4. The machine of claim 1 in which the means for removing the backing from the coil of solar film panels is a recoiling reel on which the backing is recoiled.

5. The machine of claim 1 in which the means for removing the solar film panels from the reel on which the solar film panels are coiled and the metal from the reel on which the metal is coiled is pulling by the rollformer on the combined solar film panels and metal.

6. The machine of claim 1 in which the reel for the solar panel coil has means for stopping the coil from being unwound at the proper location to allow the cutting of the metal between solar film panels without damaging the solar panels.

7. The machine of claim 1 in the means for stopping the reel for the solar panel coil from being unwound is a mechanical brake which is controlled to stop the reel at the proper location for the cutting of the metal between solar film panels.

8. The machine of claim 1 in the means for pressing the solar film panels to the metal has means for not pressing any portion of the solar film panel with electrical structure so as not to damage the electrical structure.

9. The machine of claim 1 in which there are means to reverse the metal out of the rollformer after the metal has been cut in order to align the solar film panel with the metal sheet before running the combination of the metal and solar film panel through the rollformer for configuring the metal into the desired structure.

10. The machine of claim 9 in which the means to reverse the metal out of the rollformer after the metal has been cut is a motor powering the pressure rollers to turn in reverse away from the rollformer with the machine having an indexing system to properly align the solar film panel with the metal.

11. The machine of claim 1 in which a notching device is placed between the reel for the metal and the pressure rollers for putting notches or holes in the metal prior to the combining of the metal and the solar film panels.

12. A machine for combining a thin flexible solar film panel with a metal sheet comprising:
a reel for holding a coil of metal, a reel for holding a coil of a plurality of solar film panels, each with a top and bottom, with the bottoms of the panels having an adhesive with a backing for protecting the adhesive,
with the backing being removed from the solar film panels by a recoiling reel on which the backing is recoiled,
with at least a pair of pressure rollers for pressing the solar film panels to the metal so that the adhesive on the solar film panel adheres to the metal,
a rollformer for cutting the metal of the combined metal and solar film panels into sheets and configuring the metal into the desired structure,
with the rollformer pulling the metal and solar film panels from their respective coils, and the reel for the solar film panel coil has a mechanical brake which is controlled for stopping the reel at the proper location for the cutting of the metal between solar film panels.

13. The machine of claim 12 in which there are means to reverse the metal out of the rollformer after the metal has been cut in order to align the solar film panel with the metal sheet before running the combination of the metal and solar film panel through the rollformer for configuring the metal into the desired structure.

14. A machine for combining a thin flexible solar film panel with a metal sheet comprising:
a reel for holding a coil of metal, means for holding at least one solar film panel having an adhesive with a backing for protecting the adhesive,
means for unrolling the metal from its coil,
means for placing a solar film panel on the metal,
means for removing the backing from the solar film panel,
means for pressing the solar film panels to the metal so that the adhesive on the solar film panels adheres to the metal,
a rollformer for cutting the metal between solar film panels into sheets and configuring the metal into the desired structure.

15. The machine of claim 14 in which the solar film panel is in sheet form and the holding means is a sheet stacker and there are means from removing a solar film panel from the stacker and placing it on the metal.

16. A method of combining a thin flexible solar film panel with a top and bottom, with an adhesive on the bottom and a backing protecting the adhesive, with a plurality of solar film panels coiled on a reel with metal coiled on a reel,
comprising unwinding the reel with the solar panel and the reel with metal and removing the backing from the solar film panel,
cutting the metal into sheets of desired length and aligning and pressing the solar film panels onto the metal sheet so the adhesive holds the solar film panels and metal together and configuring the metal into the desired structure by rollforming.
